(19) United States
(12) Patent Application Publication
(10) Pub. No.: US 2022/0022458 A1
(43) Pub. Date: Jan. 27, 2022

(54) COMPOSITION AND METHOD FOR REDUCING THE INFECTIVITY AND VIRUCIDAL ACTIVITY OF SARS-COV-2

(71) Applicant: Strategia Project Management, LLC, an Illinois Limited Liability Company, Oak Brook, IL (US)

(72) Inventor: Erwin LO, Spring, TX (US)

(73) Assignee: Strategia Project Management, LLC, an Illinois Limited Liability Company, Oak Brook, IL (US)

(21) Appl. No.: 17/384,629

(22) Filed: Jul. 23, 2021

Related U.S. Application Data
(60) Provisional application No. 63/055,820, filed on Jul. 23, 2020.

(51) Int. Cl. A01N 59/00; A01N 33/12; A01P 1/00

(52) U.S. Cl. CPC A01N 59/00; A01P 1/00; A01N 33/12

(57) ABSTRACT

Formulations for treating and coating surfaces resulting in reduced infectivity of SARS-Cov-2 and reduced virucidal activity. Of three different formulations, a first composition is microSURE® HS sanitizer and is a benzalkonium chloride-based formulation. A second composition is microSURE® SP sanitizer and is a quaternary ammonium (“Quat Ammonia”) based formulation. A third composition is a microSURE® silica-based sanitizing formulation containing a silica dilution of 1-to-30 in diH₂O without any chemical additives. In use, the appropriate formulation is applied to a surface desired to be protected, such as plastic, and forms a coating thereon. The coating has the effect of reducing the titer of SARS-Cov-2 after a period of as little as 30 minutes.

### FIELD OF THE INVENTION

The present disclosure generally relates to cleaning and disinfectant coatings for surfaces, and in particular surface coatings for abating the incidence of viruses.

### BACKGROUND OF THE INVENTION

A novel coronavirus was first reported in Wuhan City, Hubei Province, China and later named severe acute respiratory syndrome coronavirus 2 (SARS-CoV-2). Coronaviruses are a family of RNA viruses that have been previously identified as having six subtypes, with SARS-CoV-2 now classified as the seventh. SARS-CoV-2 spreads more efficiently than SARS-CoV from 2003 and MERS-CoV from 2015. In 2019, the disease that SARS-CoV-2 causes began to be referred to as COVID-19.

SARS-CoV-2 is spread in respiratory secretions that can take the form of airborne droplets or aerosols of saliva emanating from an infected person's cough and/or sneeze. A natural reaction is to cover one's mouth when coughing or sneezing, thereby infecting that hand used to cover the mouth. The infected hand is then used to grasp common objects such as door-knobs and the like, which creates fomites (e.g., contaminated surfaces) that are subsequently grasped by others, who become infected and spread the virus as they touch additional objects. As is typical, each of the infected persons eventually touch their face where the virus enters their body through the eyes, nose or mouth, assuring infection.

Regarding vulnerable settings, it is now obvious (though not necessarily initially appreciated) that there are particularly high concentrations of the SARS-CoV-2 virus in health care facilities where COVID-19 patients are being treated, and any abatement of the virus in that environment, as well as nursing homes, is highly desirable.

Viable SARS-CoV-2 virus capable of causing infection and/or RNA detected by RT-PCR can be found on surfaces for periods ranging from hours to days, depending on the ambient environment (particularly temperature and humidity levels) and the surface's material of the construction.

### BRIEF DESCRIPTION OF THE DRAWINGS

The following drawings form part of the present specification and are included to further demonstrate certain aspects of the present disclosure, which can be better understood by reference to the drawings in combination with the detailed description of specific embodiments presented herein. FIGS. 1-3 depict one experiment, while FIGS. 4-6 depict a second iteration of that experiment, and wherein each iteration includes graphs showing SARS-CoV-2 infectious foci on plastic treated with three different microSURE® COVID-19 abatement products, each of which is described in greater detail hereinbelow.

FIG. 1 represents the percent of infectious foci compared to deionized water (“diH₂O”)-treated slides in the first of the two experiments.

FIG. 2 presents the infectious foci per ml of infection media recovered from infected petri dishes after 30 minutes of contact time in the first of the two experiments. The data is presented in linear scale.

FIG. 3 presents the infectious foci per ml of infection media recovered from infected petri dishes after 30 minutes of contact time in the first of the two experiments. The data is presented in log scale.

FIG. 4 represents percent of infectious foci compared to diH₂O-treated slides in the second of the two experiments.

FIG. 5 presents the infectious foci per ml of infection media recovered from infected petri dishes after 30 minutes of contact time in the second of the two experiments. The data is presented in linear scale.

FIG. 6 presents the infectious foci per ml of infection media recovered from infected petri dishes after 30 minutes of contact time in the second of the two experiments. The data is presented in log scale.

### DESCRIPTION

Disclosed herein is a formulation for the treatment and coating of surfaces resulting in reduced infectivity of SARS-Cov-2 and reduced virucidal activity.

Three different formulations have been made and tested. The first composition is referred to as microSURE HS® sanitizer and is a benzalkonium chloride (“BZK”)-based formulation. The second composition is referred to as microSURE® SP sanitizer and is a quaternary ammonium (Quat Ammonia)-based formulation. The third composition is a microSURE® silica-based sanitizing formulation containing a silica dilution of 1-to-30 in diH₂O without any chemical additives.

In use, the appropriate formulation is applied to a surface desired to be protected, such as plastic, and forms a coating thereon. The coating has the effect of reducing the titer of SARS-Cov-2 after a period of as little as 30 minutes. For instance, the fluorescent focus forming unit (“FFU”) may be decreased on the order of 0.1% to 4% or more of deionized water (“diH₂O”).

While the present disclosure has been described with reference to the specific embodiments thereof, it should be understood by those skilled in the art that various changes may be made and equivalents may be substituted without departing from the true spirit and scope of the disclosure. In addition, many modifications may be made to adapt a particular situation, material, composition of matter, process, process step or steps, to the objective, spirit, and scope of the present disclosure. All such modifications are intended to be within the scope of the disclosure.

### EXAMPLE #1

In the test of Example #1, the three microSURE® sanitizer formulations were individually tested on paired plastic petri dishes. For comparison, a negative treatment control was utilized in which deionized water was applied in the same way to paired plastic petri dishes.

A coating procedure was utilized for each sanitizer application in which a 100 mm and a 60 mm petri dish was used to sandwich the virus between treated surfaces of the two dishes. In each instance, 1.0 ml of sanitizer was input into the upwardly-open bottom half of the 100 mm petri dish such that the amount of sanitizer was sufficient to coat the interior bottom surface of that 100 mm dish-half. Then, the bottom portion of the 60 mm petri dish (e.g., sufficiently small to be inserted into the open bottom half of the 100 mm petri dish) was positioned into the open bottom half of the 100 mm petri dish so that the exterior bottom surface of the 60 mm petri dish engaged with and was coated by the sanitizer contained in the larger petri dish (e.g., the 100 mm petri dish). The petri dishes sat like that for 10 minutes after which excess sanitizer coating material was removed and the dishes allowed to dry. The petri dishes were packaged in pairs with the 60 mm dish inside the now-closed 100 mm dish and stored at room temperature. The sanitizer-coated, paired petri dishes were prepared approximately three hours before tests were conducted with SARS-CoV-2.

The coated petri dishes were transferred to a Bio Safety Level 3 (BSL3) Laboratory and virus inactivation testing was conducted as follows. Triplicate dish sets were transferred into a Bio Safety Cabinet (BSC) and 20 μl of SARS-CoV-2 virus (5e6 FFU/ml, so total of 1e5 FFU) was placed on the treated interior bottom surface of the 100 mm petri dish. The virus that was utilized was the SARS-CoV-2, Isolate USA-WA1/2020 (BEI Resources, NR-52281). Thereafter, the 60 mm petri dish was placed on top, sandwiching the inoculum between the dishes.

The so-configured dishes were incubated at room temperature in a humidified box for 30 minutes. The paired dishes were then separated and rinsed 5 times with the same 0.5 ml of infectious media (e.g., DMEM with 2% FBS and antibiotics), which was retained. The retained 0.5 ml of infectious media was then transferred to sterile tubes and tested in an FFU assay.

FFU assays were performed to immunostain for focus-forming units. To each well of a 96-well plate seeded with Vero cells, 50 μl neat media (e.g., from petri dish rinsing) was added and diluted 10-fold to 10⁻⁵. The plates were incubated for one hour and then overlayed with 50 μl Methycellulose medium. That was then incubated for approximately 24 hours at 37° C. and 5% CO₂. The media was removed and thereafter washed with PBS and fixed plates with 80:20 MeOH:Acetone. The plates were removed from the BSL3 Laboratory following approved protocols. The plates were then immunostained with anti-SARS-CoV-2 Spike mAb, 1C02, using anti-human IgG-HRP to visualize FFU. The FFU were counted and then the diH₂O-treated were compared to the test material (e.g., sanitizers) treated coverslips.

### EXAMPLE #1 RESULTS

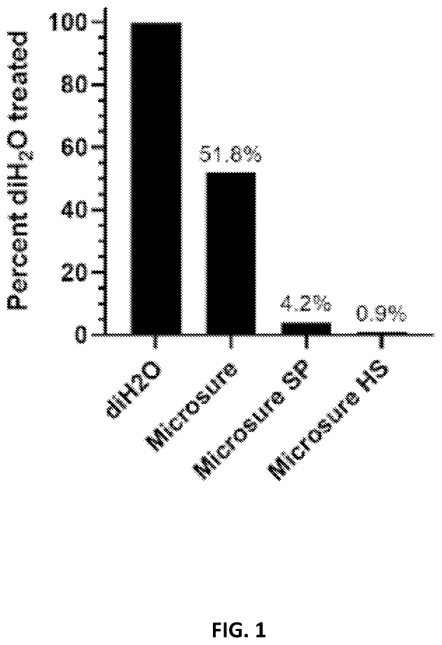

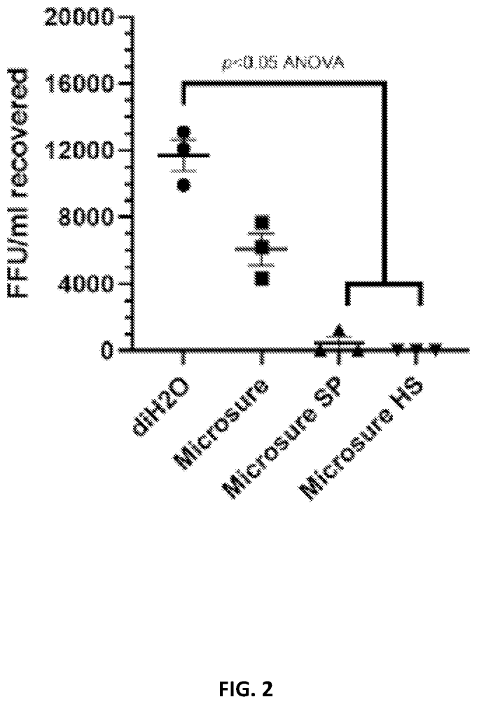

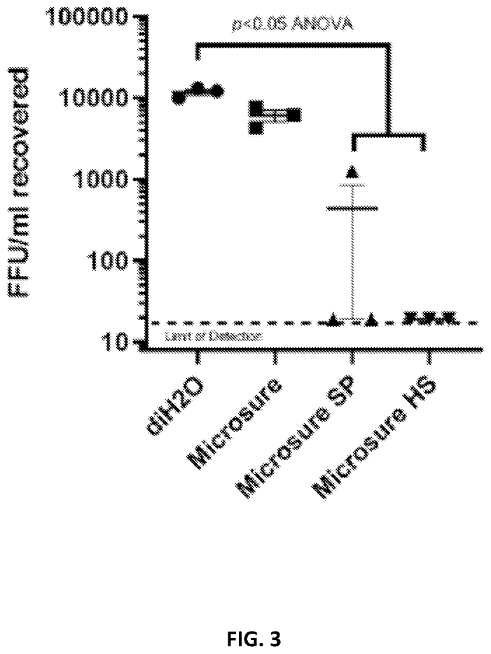

Plastic treated with microSURE® silica-based sanitizing formulation at the recommended dilution (1:30), after 30 minutes, reduced the average titer of SARS-CoV-2 by 0.9% compared to diH₂O treated surfaces as shown in FIG. 1, but which was not considered statistically significant as depicted in FIG. 2. In contrast, microSURE SP® sanitizer and microSURE HS® sanitizer treatments on plastic significantly reduced the titer of SARS-CoV-2 compared to diH₂O treated surfaces after 30 minutes of contact time. As depicted in FIGS. 2 and 3 the average FFU was decreased to 3.72% and 0.16% of diH₂O FFU for microSURE SP® sanitizer and microSURE HS® sanitizer, respectively, and were statistically significant, having a p<0.05 ANOVA, Krusjak-Wallis test, post hoc Dunn's multiple comparison test.

### EXAMPLE #2

In the test of Example #2, the three microSURE® sanitizer formulations were individually tested on paired plastic petri dishes. For comparison, a negative treatment control was utilized in which deionized water was applied in the same way to paired plastic petri dishes.

A coating procedure was utilized for each sanitizer application in which a 100 mm and a 60 mm petri dish were used to sandwich the virus between treated surfaces of the two dishes. In each instance, 1.0 ml of sanitizer was input into the upwardly-open bottom half of the 100 mm petri dish such that the amount of sanitizer was sufficient to coat the interior bottom surface of that 100 mm dish-half. Then, the bottom portion of the 60 mm petri dish (e.g., sufficiently small to be inserted into the open bottom half of the 100 mm petri dish) was positioned into the open bottom half of the 100 mm petri dish so that the exterior bottom surface of the 60 mm petri dish engaged with and was coated by the sanitizer contained in the larger petri dish (e.g., the 100 mm petri dish). The petri dishes sat like that for 10 minutes after which excess sanitizer coating material was removed and the dishes allowed to dry. The petri dishes were packaged in pairs with the 60 mm dish inside the now-closed 100 mm dish and stored at room temperature. The sanitizer-coated, paired petri dishes were prepared approximately three hours before tests were conducted with SARS-CoV-2.

The coated petri dishes were transferred to a Bio Safety Level 3 (BSL3) Laboratory and virus inactivation testing was conducted as follows. Quintuplicate replicates were run of diH₂O treatments as control petri dishes. Sextuplicate sanitizer-treated dish sets (e.g., six replicates) were transferred into a Bio Safety Cabinet (BSC) and 20 μl of SARS-CoV-2 virus (5e6 FFU/ml, so total of 1e5 FFU) was placed on the treated interior bottom surface of the 100 mm petri dish. The virus that was utilized was the SARS-CoV-2, Isolate USA-WA1/2020 (BEI Resources, NR-52281). Thereafter, the 60 mm petri dish was placed on top, sandwiching the inoculum between the dishes.

The so-configured dishes were incubated at room temperature in a humidified box for 30 minutes. The paired dishes were then separated and rinsed 5 times with the same 0.5 ml of infectious media (e.g., DMEM with 2% FBS and antibiotics), which was retained. The retained 0.5 ml of infectious media was then transferred to sterile tubes and tested in an FFU assay.

FFU assays were performed to immunostain for focus-forming units. To each well of a 96-well plate seeded with Vero cells, 50 μl neat media (e.g., from coverslip rinsing) was added and diluted 10-fold to 10⁻⁵. The plates were incubated for one hour and then overlayed with 50 μl Methycellulose medium. That was then incubated for approximately 24 hours at 37° C. and 5% CO₂. The media was removed and thereafter washed with PBS and fixed plates with 80:20 MeOH:Acetone. The plates were removed from the BSL3 Laboratory following approved protocols. The plates were then immunostained with anti-SARS-CoV-2 Spike mAb, 1C02, using anti-human IgG-HRP to visualize FFU. The FFU were counted and then the diH₂O-treated were compared to the test material (e.g., sanitizers) treated coverslips.

### EXAMPLE #2 RESULTS

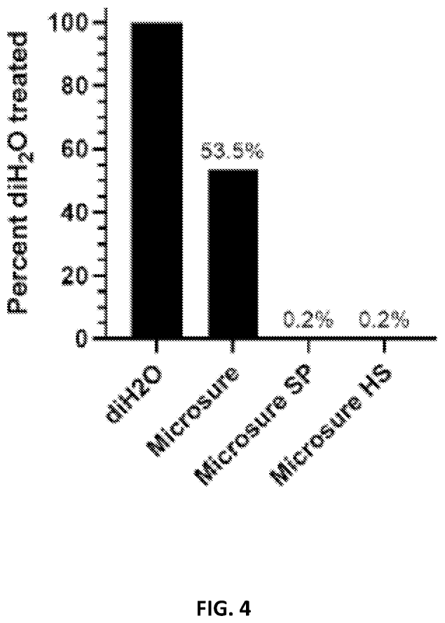

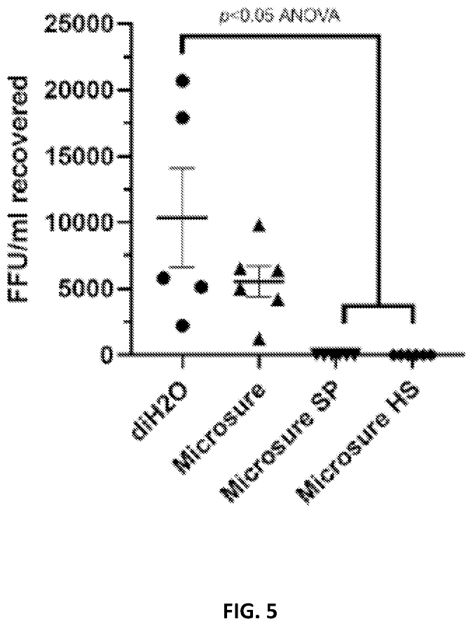

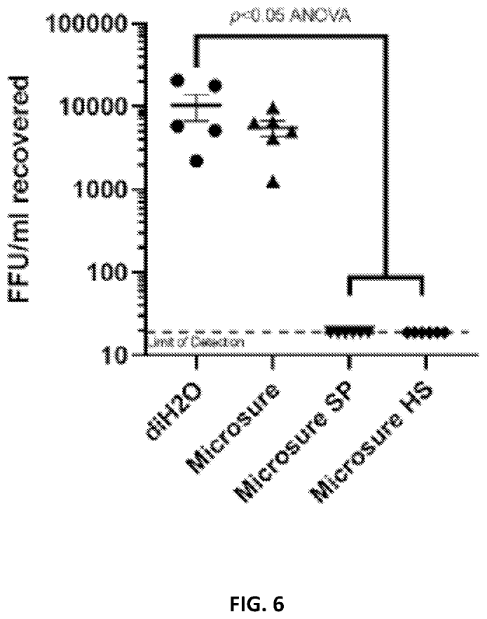

Plastic treated with microSURE® silica-based sanitizing formulation at the recommended dilution (1:30), after 30 minutes, reduced the average titer of SARS-CoV-2 by 0.2% compared to diH₂O treated surfaces as shown in FIG. 4, but which was not considered statistically significant as depicted in FIG. 5. In contrast, microSURE SP® sanitizer and microSURE HS® sanitizer treatments on plastic significantly reduced the titer of SARS-CoV-2 compared to diH₂O treated surfaces after 30 minutes of contact time. As depicted in FIGS. 5 and 6 the average FFU was decreased to less than to 0.18% of diH₂O FFU for both microSURE SP® sanitizer and microSURE HS® sanitizer, which is statistically significant, having a p<0.05 ANOVA, Krusjak-Wallis test, post hoc Dunn's multiple comparison test.

Surfaces treated with microSURE SP® sanitizer and microSURE HS® sanitizer significantly reduced infectivity of SARS-CoV-2 after 30 minutes of contact time. This was considered biologically relevant virucidal activity, reducing infectious virus by at least 99.8% in one study. Virucidal activity could be greater as the reduction is limited by the detection ability of the assay. Surfaces treated with microSURE® silica-based sanitizing formulation containing a silica dilution of 1-to-30 in diH₂O without any chemical additives reduced infectivity by almost 50%. While a consistent result, this was not statistically significant and is not considered biologically relevant virucidal activity. One reason for this is that the surfaces were tested for virucidal activity within approximately three hours of coating. Longer periods of time between treatment and testing may result in changes to virucidal activity of the microSURE® silica-based sanitizing formulation. Another reason is that virucidal activity may be greater than reported for microSURE SP® sanitizer and microSURE HS® sanitizer because, in one assay, both treatments resulted in undetectable infectious viruses.

What is claimed is:

1. A composition comprising microSURE® silica-based sanitizing formulation.

2. The composition of claim 1, further comprising Benzalkonium chloride (“BZK”).

3. The composition of claim 1, further comprising a quaternary ammonium (“Quat Ammonia”).

4. A process comprising applying microSURE® silica-based sanitizing formulation to a surface to form a coating and abate SARS-CoV-2.

5. The process of claim 4, further comprising Benzalkonium chloride (“BZK”).

6. The process of claim 4, further comprising a quaternary ammonium (“Quat Ammonia”).
